(19) United States
(12) Patent Application Publication
(10) Pub. No.: US 2008/0222897 A1
(43) Pub. Date: Sep. 18, 2008

(54) KNIFE WITH BLADE STOP STRUCTURE

(75) Inventors: Anthony L. Marfione, Bradford, PA (US); Anthony G. Marfione, Bradford, PA (US)

Correspondence Address: FAY SHARPE LLP, 1100 SUPERIOR AVENUE, SEVENTH FLOOR, CLEVELAND, OH, 44114, US

(73) Assignee: MICROTECH KNIVES, INC., Bradford, PA (US)

(21) Appl. No.: 11/684,833

(22) Filed: Mar. 12, 2007

(51) Int. Cl. B26B 3/06

(52) U.S. Cl. 30/162

(57) ABSTRACT

A slide knife with a blade stop structure is disclosed. The knife comprises a blade, an actuator, and a handle. The handle comprises a frame and a cover. The blade has a blade pin. The cover comprises an extended stop with an interior surface and/or a stop boss that engages the blade pin. The actuator also comprises a front catch which may engage the blade pin. The blade stop structure can absorb the force imparted by continual striking of the blade pin without distortion of the knife.

### BACKGROUND

Knives that have blades which move from a sheathed position to a unsheathed use position are well known. They can be broadly classified into two types, depending on the movement between the positions. In a slide knife, the blade slides from a sheathed position, usually inside the handle of the knife, to an exposed use position out the front of the handle. In a folding knife, the blade pivots about an axis normal to a common plane of the handle and blade between a sheathed position within the handle through an arc to a use position external of the handle. A lock then prevents the blade from pivoting on the axis during use.

A slide knife can comprise a blade and a handle. The handle may be formed from a frame and a cover. It is known to use a spring to provide energy that starts the movement of the blade from its sheathed position to its exposed use position. After the spring has discharged, the momentum of the blade finishes the motion of the blade into its exposed position. The blade is normally prevented from exiting the knife by a blade pin located on the tang of the knife on the side facing the frame. The blade pin strikes an extended surface of the frame, stopping the momentum of the blade.

Normally, the blade pin is steel and the frame is aluminum. Because aluminum is softer than steel, the frame becomes distorted as the blade pin continually strikes the extended surface. This distortion damages the knife. A slide knife which can resist the continuous striking of the blade pin is therefore desirable.

### BRIEF DESCRIPTION

Disclosed herein, in various embodiments, is a slide knife with a blade stop structure. The knife comprises a blade and a handle. The handle comprises a frame and a cover.

In one exemplary embodiment, the blade has a tang and a blade pin is located on the face of the tang facing the cover. The frame defines a pin channel within which the pin travels. The cover comprises an extended stop which extends into the pin channel at the front end of the handle and is shaped to receive a stop boss. A stop boss is mounted in the extended stop, the stop boss being made of a material at least as hard as the blade pin.

In further embodiments, the extended stop comprises an interior surface shaped to receive the blade pin. The interior surface may be made of a material not as hard as the blade pin.

In further embodiments, the knife further comprises an actuator, a front spring catch, and a rear spring catch. The front spring catch is located near the top and the front of the frame. The rear spring catch is located near the bottom and the rear of the frame. The actuator is shaped so as to engage each spring catch separately.

In further embodiments, the handle further comprises a rear wall. The tang has a length defined by a blade catch and a blade rear wall, and the rear spring catch is located so that the tang fits between the rear spring catch and the handle rear wall.

In further embodiments, the front spring catch and the extended stop are located so as to prevent the blade from moving substantially in a frontward or rearward direction when the blade is between the front spring catch and the extended stop.

In further embodiments, the actuator further comprises a spring assembly, the spring assembly comprising a front catch, a rear catch, and a spring connecting the front catch and the rear catch. The blade further comprises a blade recess located on the rear of the blade and the rear catch has a blade interface that fits into the blade recess. In some embodiments, the actuator has a rear end and the rear catch does not extend beyond the rear end.

In further embodiments, the knife further comprises a fastener system that attaches the frame and cover together.

In another exemplary embodiment, the blade has a tang and a blade pin is located on the face of the tang facing the cover. The frame defines a pin channel within which the pin travels. The cover comprises an extended stop which extends into the pin channel at the front end of the handle and is shaped to receive a stop boss. The knife further comprises an actuator comprising a spring assembly. The spring assembly comprises a stop boss that extends beyond a front end of the actuator and has a width sufficient to engage the blade pin.

In further embodiments, the stop boss has an outer edge segment that has the shape of a convex semicircle or arc and the extended stop has an interior surface comprising a concave semicircle or arc of the same shape as the outer end.

In further embodiments, the spring assembly further comprises a rear catch and a spring connecting the stop boss and the rear catch. The blade further comprises a blade recess located on the rear of the blade. The rear catch has a blade interface that fits into the blade recess. In some embodiments, the actuator has a rear end and the rear catch does not extend beyond the rear end.

In further embodiments, the knife further comprises a front spring catch and a rear spring catch. The front spring catch is located near the top and the front of the frame. The rear spring catch is located near the bottom and the rear of the frame. The actuator is shaped so as to engage each spring catch separately.

In further embodiments, the handle further comprises a rear wall. The tang has a length defined by a blade catch and a blade rear wall and the rear spring catch is located so that the tang length is substantially equal to or less than the distance between the rear spring catch and the rear wall. In other words, the distance between the rear spring catch and the rear wall may be substantially equal to or greater than the tang length

In further embodiments, the front spring catch and the extended stop are located so as to prevent the blade from moving substantially in a frontward or rearward direction when the blade is between the front spring catch and the extended stop.

These and other features of the present disclosure are further described herein.

### BRIEF DESCRIPTION OF THE DRAWINGS

The following is a brief description of the drawings, which are presented for the purposes of illustrating the exemplary embodiments disclosed herein, not for limiting them.

FIG. 1 is an exterior perspective view of the knife of the present disclosure.

FIG. 2 is a side view of the knife blade.

FIG. 3 is a top view of the knife blade.

FIG. 4 is a cross-sectional view of the frame of the knife handle.

FIG. 5 is a side view of the interior of the frame of the knife handle.

FIG. 6 is a top view of the frame of the knife handle.

FIG. 7 is an enlarged view of the front spring catch mechanism.

FIG. 8 is a front view of the cover of the knife handle.

FIG. 9 is a side view of the interior of the cover of the knife handle.

FIG. 10 is an enlarged side view of the front end of the cover of the knife handle.

FIG. 11 is a cross-sectional view of the cover of the knife handle.

FIG. 12 is a cover facing side view of the actuator.

FIG. 13 is a frame facing side view of the actuator.

FIG. 14 is a cover facing view of the spring assembly.

FIG. 15 is a top view of the spring assembly.

FIG. 16 is a frame facing view of the spring assembly.

FIG. 17 is a cover facing view of the actuator with the spring assembly attached.

FIG. 18 is a top view of the actuator with the spring assembly attached.

FIG. 19 is a side view of the knife with the blade in a sheathed position.

FIG. 20 is a view similar to FIG. 19 showing the knife at the beginning of the blade deployment cycle.

FIG. 21 is a view similar to FIGS. 19 and 20 showing the knife with the trigger fully forward.

FIG. 22 is a view similar to FIG. 19 showing the blade in an intermediate position.

FIG. 23 is a view similar to FIG. 19 showing the blade in an exposed use position.

FIG. 24 is a first embodiment of the blade stop structure.

FIG. 25 is a second embodiment of the blade stop structure.

FIG. 26 is a view similar to FIG. 19 showing the knife at the beginning of the blade retraction cycle.

### DETAILED DESCRIPTION

A more complete understanding of the knives and components disclosed herein can be obtained by reference to the accompanying Figures. These Figures are merely schematic representations based on convenience and the ease of demonstrating the present development and are, therefore, not intended to indicate relative size, dimensions, or location of the devices or components thereof and/or to define or limit the scope of the exemplary embodiments. Although specific terms are used in the following description for the sake of clarity, these terms are intended to refer only to the particular structure of the embodiments selected for illustration in the Figures and are not intended to define or limit the scope of the disclosure. In the Figures and the following description below, it is to be understood that like numeric designations refer to components of like function.

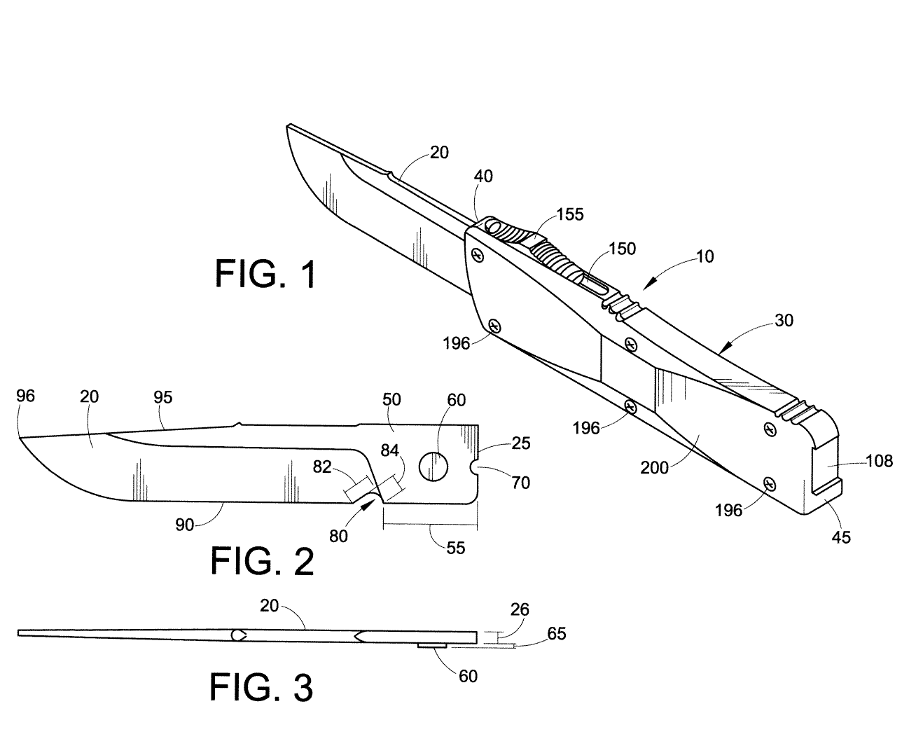

FIG. 1 is an exterior view of the knife of the present disclosure. The knife 10 comprises a blade 20 and a handle 30. The knife 10 has a front end 40 from which the blade 20 extends.

With reference to FIG. 2, the blade 20 has a tang 50. A blade pin 60 extends from one side of the tang 50 (see top view of FIG. 3). The blade pin 60 shown is cylindrical. A blade recess 70 having an arcuate shape is located on the rear wall 25 and is used to move the blade 20 from its sheathed position to its extended use position, as explained herein. A blade catch 80 is located on the bottom 90 of the blade 20. The blade catch 80 comprises an angled surface 82 which extends into the blade 20 until it intersects a catch surface 84 which extends substantially perpendicularly from the bottom 90 into the blade 20 as well. In otherwords, the blade catch 80 resembles a right triangle taken out of the blade 20. The blade catch 80 is used to hold the blade 20 in its sheathed position, as explained herein. The tang 50 has a tang length 55 defined by the distance between the blade catch 80 and the rear wall 25 of the blade. The blade top 95 tapers upwards from the front 96 of the blade to the tang 50. This tapering feature is used to allow the blade 20 to move into an extended use position, as explained herein. The blade 20 has a blade width 26 at the tang 50 and the blade pin has a pin width 65.

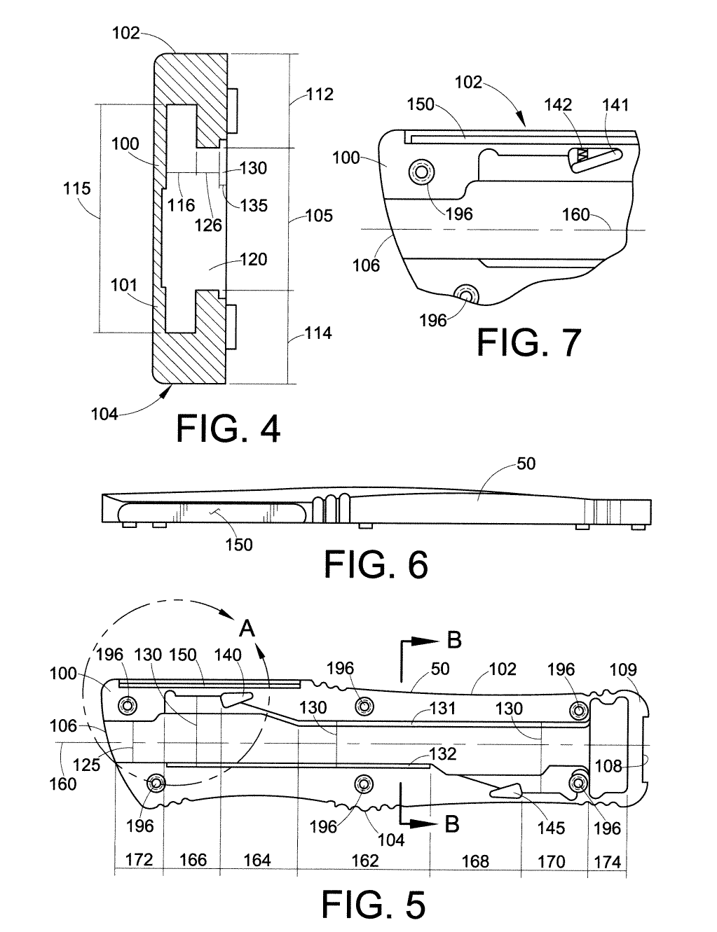

The knife handle 30 comprises a frame 100 and a cover 200. FIGS. 4-6 are various views of the handle frame 100. FIG. 4 is a cross-sectional view of the frame 100 taken along line B-B (shown in FIG. 5) and looking towards the rear wall 109 of the frame. With reference to FIG. 4, the frame 100 defines a blade channel 110 and a pin channel 120. The blade channel 110 has a width 116 substantially equal to the blade width 26 throughout the length of the frame 100. The pin channel 120 has a width 126 at least equal to the pin width 65 throughout the length of the frame 100. The height 115 of the blade channel 110 remains substantially the same throughout the length of the frame 100. The height 125 of the pin channel 120 is at least equal to that of the diameter of the blade pin 60 throughout the length of the frame 100.

From the front, the frame 100 resembles the letter C (see FIG. 4). The frame 100 comprises a sidewall 101, a top 102, and a bottom 104. On the portion of the frame that is inside the handle (when the frame 100 and cover 200 are assembled), an upper portion 112 is connected to the top 102 and a lower portion 114 is connected to the bottom 104. In between the upper portion 112 and lower portion 114, there is a gap 107 (not shown) of height 105. The gap 107 comprises the pin channel 120. The height 125 of the pin channel 120 is included within the gap height 105; they are not exactly equal. The frame 100 also has a rear wall 109 (see FIG. 5).

In addition, the frame defines an actuator channel 130. As seen in FIG. 4, the width 135 of the actuator channel 130 remains the same throughout the length of the frame 100. However, the height of the actuator channel 130 varies along the length of the frame 100 (see FIG. 5). Actuator channel 130 is defined by a top wall 131 and a bottom wall 132. The top wall 131 and bottom wall 132 are located completely within the interior of the handle 30 and are not visible from the front end 40 or the rear end 45 of the knife.

The interior of the frame 100 is divided into seven different segments 162, 164, 166, 168, 170, 172, and 174. Segment 162 is located in the middle of the frame. The top wall 131 and the bottom wall 132 are substantially equidistant from the midline 160 for the entire segment 162. As the top wall 131 extends toward the front end 106 of the frame, it enters segment 164. In segment 164, the top wall 131 tapers closer to the top 102 of the frame until it intersects front spring catch 140. The bottom wall 132 runs parallel to the midline 160 for the entire segment 164. After the top wall 131 intersects front spring catch 140, it enters segment 166.

In segment 166, the top wall 131 runs parallel to the midline 160 for the entire segment. At the end of segment 166 nearest the front end 106, the top wall 131 turns perpendicularly towards the midline 160. The bottom wall 132 runs parallel to the midline 160 for the entire segment 166. Then, at the end of segment 166 nearest the front end 106, the bottom wall 132 also turns perpendicularly towards the midline 160. The top wall 131 and bottom wall 132 run towards each other and terminate so that there is at least a distance equal to gap height 105 between them. Segment 172 then extends all the way to the front end 106 of the frame.

Returning to segment 162, as the top wall extends toward the rear end 108 of the handle, it enters segment 168. The top wall 131 runs parallel to the midline 160 for the entire segment 168. As the bottom wall 132 enters segment 168, it tapers closer to the bottom 104 of the frame until it intersects rear spring catch 145 about halfway through the height of the rear spring catch 145. After the bottom wall 132 intersects rear spring catch 145, it enters segment 170. The bottom wall 132 runs parallel to the midline 160 for the entire segment 170. Then, at the end of segment 170 nearest the rear end 108, the bottom wall 132 turns perpendicularly towards the midline 160 and terminates. The top wall 131 runs parallel to the midline 160 for the entire segment 170. At the end of segment 170 nearest the rear end 108, the top wall 131 terminates. There is at least a distance equal to gap height 105 between the top wall 131 and 132 at the end of segment 170. Segment 174 then extends all the way to the rear end 108 of the frame. Segment 174 contains a cavity which has a width substantially equal to the sum of the blade width 26, pin width 65, and actuator channel width 135.

The frame 100 has a front spring catch 140 and a rear spring catch 145. FIG. 7 is an enlarged view of the portion of the frame 100 denoted by circle A in FIG. 5. Referring to FIG. 7, the front spring catch 140 comprises a rectangular piece of metal 141 located near the top 102 of the frame near the front end 106 of the handle. The rectangular piece 141 pivots about an axis near the top 102 of the frame on the end that is closer to the middle of the length of the frame 100. A spring 142 pushes the rectangular piece of metal 141 down from the top 102 of the frame. The frame is shaped so that the rectangular piece can only travel within an arc of about 15 degrees. When the front spring catch 140 is activated (i.e. the spring 142 is pushing the rectangular piece 141 down), the front spring catch 140 intersects the blade channel 110 and the actuator channel 130, but not the pin channel 120. When the front spring catch 140 is deactivated (i.e. something is pushing the spring 142 and the rectangular piece 140 back into the top 102), the front spring catch 140 does not intersect the blade channel 110 or the actuator channel 130.

The rear spring catch 145 (not pictured) works the same way as the front spring catch. However, it is located near the bottom 104 of the frame at the rear end 108 of the frame. Its rectangular piece pivots about an axis near the bottom 104 of the frame on the end that is closer to the middle of the length of the frame 100 and its spring pushes the rectangular piece of metal up from the bottom 104 of the frame. When the rear spring catch 145 is activated (i.e. the spring is pushing the rectangular piece up), the rear spring catch 145 intersects the blade channel 110 and the actuator channel 130, but not the pin channel 120. When the rear spring catch 145 is deactivated (i.e. something is pushing the spring and the rectangular piece down), the rear spring catch 145 does not intersect the blade channel 110 or the actuator channel 130.

Referring again to FIGS. 5 and 6, the frame 100 also has a trigger channel 150 for the trigger 155 (see FIG. 1 for the trigger 155). The trigger channel 150 is located on the top 102 of the frame near the front end 106 of the handle. The trigger channel runs over the portion of the actuator channel 130 that is closer to the top 102 and the front spring catch 140 also. However, the trigger channel 150 and the actuator channel 130 do not actually intersect; they are still separated by a thin piece of the frame 100.

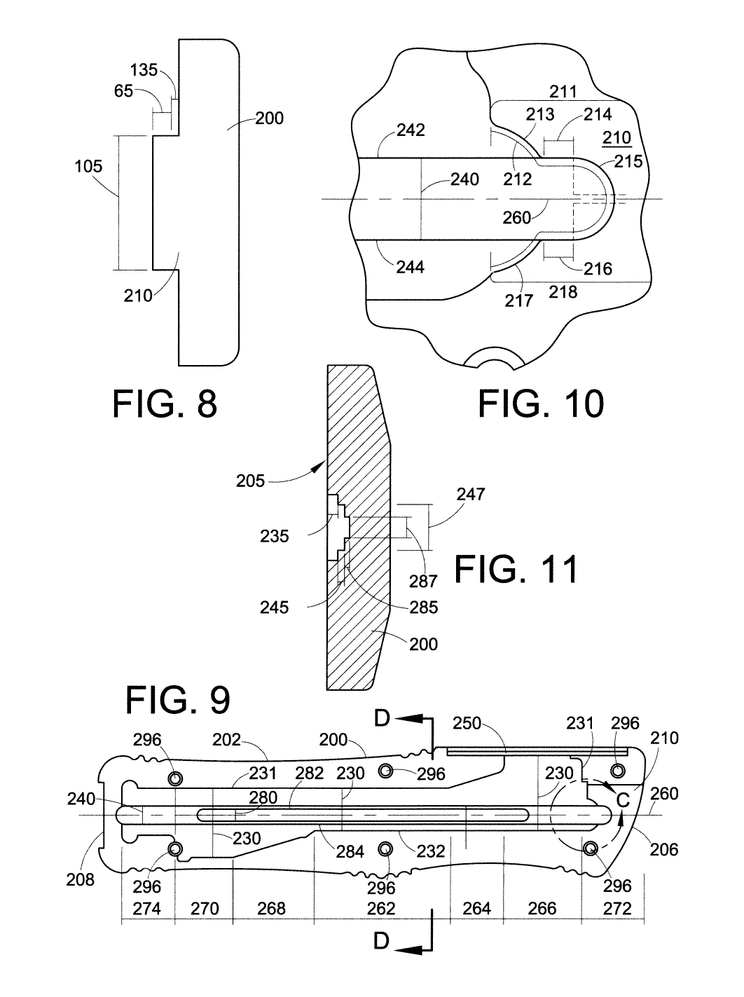

FIG. 8 is a front view of the cover 200. FIG. 9 is a side view of the cover 200. The cover 200 comprises a sidewall 201 and an extended stop 210 located near the front end 206 of the cover. The extended stop 210 has a width substantially equal to the sum of the pin width 65 and the actuator channel width 135. The extended stop 210 has a height equal to that of the gap height 105 and fits into the gap 107 of the frame 100 at the front end 106 of the frame.

FIG. 10 is an enlarged view of the front end of the cover of the knife handle denoted by circle C in FIG. 9. The extended stop 210 is wholly located within segment 272 of the interior of the cover 200. The extended stop has top surface 211 which runs parallel to the midline 260 of the cover from the front end 206 into the interior of the cover. There, the top surface intersects interior surface 212, which is not visible when the frame 100 and cover 200 are assembled to form the handle 30. The interior surface 212 comprises two stop arcs 213 and 217 which are arcs of the same circle and whose center is further away from the front end 206 than the interior surface 212. Stop arcs 213 and 217 may be considered concave arcs as well. One end of stop arc 213 intersects top surface 211. The other end of stop arc 213 extends into the interior and towards the midline 260 to intersect line segment 214. Line segment 214 runs with the catch channel top 242 parallel to the midline 260 back out towards the front end 206. Line segment 214 then intersects one end of semicircle 215. The diameter of the semicircle is perpendicular to the midline 260 and the semicircle is concave (i.e. it extends towards the front end 206). The other end of semicircle 215 intersects line segment 216, which runs with the catch channel bottom 244 back into the interior of the cover. Line segment 216 then intersects one end of stop arc 217. The other end of stop arc 217 extends into the interior and towards the bottom 206 of the cover, where it intersects bottom surface 218. Bottom surface 218 runs parallel to the midline 60 from the interior of the cover to the front end 206. Semicircle 215 can be considered as terminating one end of the catch channel 240. Note from this description that top surface 211, line segment 214, line segment 216, and bottom surface 218 are all parallel to each other. Interior surface 212 is substantially perpendicular to the plane of the sidewall 201 (see FIG. 8).

Referring to FIG. 9, three channels are present in the cover 200: actuator channel 230, catch channel 240, and spring channel 280. FIG. 11 is a cross-sectional view of FIG. 9 taken at line D-D looking from the front of the cover towards the rear of the cover. As seen in FIG. 11, the three channels generally have constant widths. Actuator channel 230 is nearest the interior surface 205 of the cover and has width 235. Catch channel 240 has width 245 and height 247. Spring channel 280 has width 285 and height 287.

Actuator channel 230 is similar to the actuator channel 130 in the frame 100. The width 235 of the actuator channel 230 remains the same throughout the length of the cover 200. However, the height of the actuator channel 230 varies along the length of the cover 200 (see FIG. 5). Actuator channel 230 is defined by a top wall 231 and a bottom wall 232. The top wall 231 and bottom wall 232 are located completely within the interior of the handle 30 and are not visible from the front end 40 or the rear end 45 of the knife. The interior of the cover 200 is divided into seven different segments 262, 264, 266, 268, 270, 272, and 274. Segment 262 is located in the middle of the cover. The top wall 231 and the bottom wall 232 are substantially equidistant from the midline 260 for the entire segment 262. As the top wall 231 extends toward the front end 206 of the cover, it enters segment 264. In segment 264, the top wall 131 tapers closer to the top 202 of the cover. At the end of segment 264, the top wall 131 stops tapering and runs parallel to the midline 260 towards the top 202 of the cover until it intersects the trigger channel 250, where the top wall ends. There is no top wall 131 for much of segment 266, but in segment 272 top wall 131 comes down from the trigger channel 250 until it intersects top surface 211 and stop arc 212. Top wall 131 then follows stop arc 212 and terminates at line segment 214. The bottom wall 232 runs parallel to the midline 260 throughout segments 264 and 266. In segment 272, the bottom wall 232 then extends toward the midline 260 until it intersects bottom surface 218 and stop arc 217. Bottom wall 232 then follows stop arc 217 and terminates at line segment 216.

Returning to segment 262, as the top wall extends toward the rear end 208 of the handle, it enters segment 268. The top wall 231 runs parallel to the midline 260 for the entire segment 268. As the bottom wall 232 enters segment 268, it tapers closer to the bottom 204 of the cover, then enters segment 270 where it levels off and again runs parallel to the midline 260. At the end of segment 270 nearest the rear end 208, the bottom wall 232 turns perpendicularly towards the midline 260 and reduces its distance from the midline by about one-half. The top wall 231 maintains its distance from the midline 260 for the entire segment 270. Then, in segment 274, the top wall 231 continues parallel to the midline 260 for about one-half of segment 274, then turns perpendicularly towards the midline 260 and returns to the midline 260. In segment 274, the bottom wall 231 continues parallel to the midline 260 for about one-half of segment 274, then turns perpendicularly towards the midline 260 and returns to the midline 260. At the midline, top wall 231 and bottom wall 232 join each other.

Catch channel 240 comprises a channel top 242 and channel bottom 244 (see FIG. 10). The top 242 and bottom 244 run parallel to the midline 260 through the entirety of segments 262, 264, 266, and 268. They are closer to the midline 260 than the actuator top wall 231 and the actuator bottom wall 232. They are also substantially equidistant from the midline 260. In segment 272 at the front end 206 of the cover, the catch channel 240 terminates in a semicircle which follows semicircle 215. In segment 274 at the rear end 208 of the cover, the top 242 and bottom 244 return to the midline and join each other. Although FIG. 9 shows this end of the catch channel 240 as a semicircle also, this aspect is not required.

Spring channel 280 comprises a channel top 282 and channel bottom 284. The top 282 and bottom 284 run parallel to the midline 260 through the entirety of segments 262, 264, and 268. They are closer to the midline 260 than the catch channel top 242 and the catch channel bottom 244. They are also substantially equidistant from the midline 260. In segment 266, the spring channel 280 terminates in a semicircle at a location which is under the portion where no actuator top wall 231 is present. In segment 270, the top 282 and bottom 284 return to the midline and join each other. Although FIG. 9 shows this end of the spring channel 280 as a semicircle also, this aspect is not required. Generally, spring channel 280 has a total length which is greater than actually required by the spring that travels within it (discussed further herein).

The frame 100 and the cover 200 are attached together to form the handle 30. The knife 10 also comprises a fastener system to attach the frame 100 and the cover 200. The fastener system may be, for example, a series of threaded bores and machine screws to hold them together. In FIG. 5, the frame 100 has six threaded bores 196, and in FIG. 9, the cover 200 has six holes 296. They line up with each other and when bolts (not shown) are put through them, the handle 30 is formed.

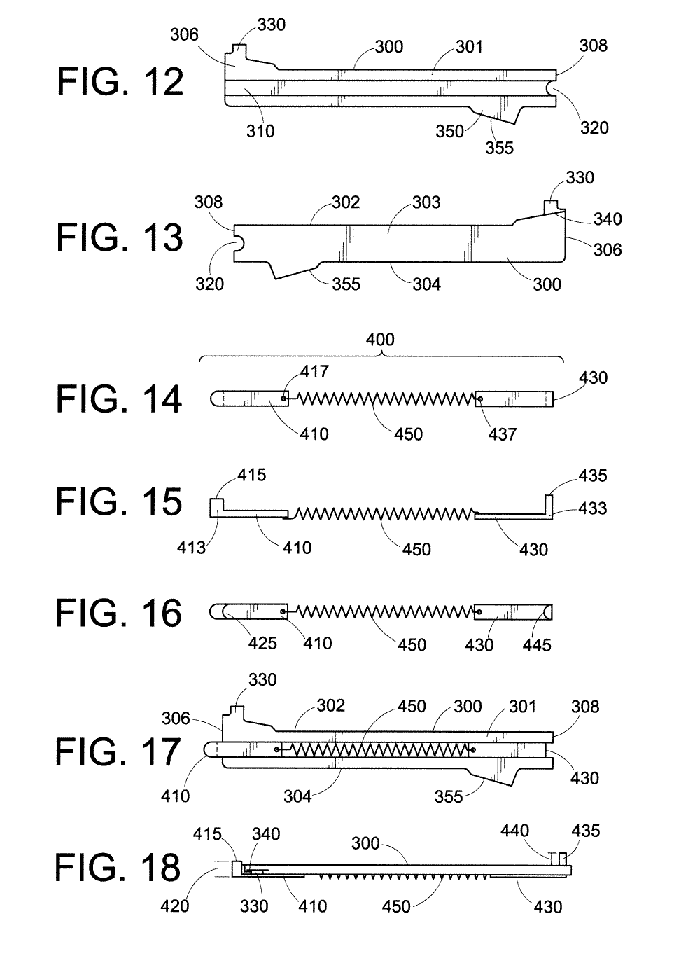

Between the frame 100 and the cover 200 is an actuator 300. The actuator 300 is a piece having a small width and fits in the actuator channels 130 and 230 of the frame 100 and cover 200. The two faces of the actuator 300 are different. FIG. 12 shows the cover face 301, which is the face that engages the cover 200. The actuator 300 has a front end 306 which faces the front end 40 of the knife and a rear end 308 which faces the rear end 45 of the knife. A spring assembly channel 310 runs from the front end 306 to the rear end 308 parallel to the top 302 of the actuator 300. An actuator recess 320 is located on the rear end 308 in line with the spring assembly channel 310. On the cover face, at the front end 306 on the top 302 of the actuator, a trigger connector 330 extends away from the actuator. On the frame face 303 and approximately behind the trigger connector 330, a sloped ramp 340 tapers upwards from the top 302 to the front end 306 and ends at a height less than that of the trigger connector 330 (see FIG. 13). At the bottom 304 of the actuator, near the rear end 308, the actuator has a rear spring catch interface 350 which comprises an angled face 355 tapering out from the bottom 304 of the actuator.

The spring assembly channel 310 holds a spring assembly 400, which is shown in FIGS. 14-16. The spring assembly 400 comprises a front catch 410 having an outer end 413 and an inner end 417. The outer end 413 is a convex semicircle when seen from the frame face view of FIG. 16. The front catch 410 has projection 415 and is essentially L-shaped. The face of projection 415 facing the inner end 417 is a concave arc 425. The spring assembly 400 also comprises a rear catch 430 having an outer end 433 and an inner end 437. The rear catch 430 has a blade interface 435 and is L-shaped. The face of the blade interface 435 facing the inner end 437 is a convex arc 445. The front catch 410 and rear catch 430 are connected to each other at their inner ends 417, 437 by a spring 450.

Referring now to FIGS. 17 and 18, when the spring assembly 400 is placed in the spring assembly channel 310, tension from the spring 450 holds the front catch 410 and the rear catch 430 in the spring assembly channel 310. The blade interface 435 fits in the actuator recess 320 and extends past the frame face 303. Note that the rear catch 430 does not extend all the way to the rear end 308 of the actuator. The projection 415 of the front catch 410 extends beyond the front end 306 of the actuator. This configuration of the spring assembly is considered its resting position. The front catch portion has width 420. The portion of the blade interface 435 extending beyond the frame face 303 has width 440. The blade interface width 440 is great enough that the blade interface intersects the blade 20 and fits in blade recess 70 (see FIG. 2). The front catch width 420 is, at a minimum, great enough so that the front catch 410 can maintain tension in the spring 450. The front catch width may also be great enough to intersect the pin 60.

The parts of the components interact with each other when the knife 10 is assembled. The various segments within the frame 100 and the cover 200 generally align with each other. In other words, segment 162 generally aligns with segment 262, segment 164 generally aligns with segment 264, and so on for segment combinations 166/266, 168/268, 170/270, 172/272, and 174/274. In particular, the top walls 131/231 and the bottom walls 132/232 defining the actuator channels 130/230 align with each other. The actuator 300 fits in the space defined by actuator channels 130 and 230. The spring assembly 400, particularly the front catch 410 and rear catch 430 fit in the catch channel 240 in the cover. The portion of the spring 450 that extends beyond the catch channel 240 fits in the spring channel 280. The blade 20 fits in the blade channel 110 and the blade pin 60 fits in the pin channel 120. The blade interface 435 fits into the blade recess 70.

When the blade 20, frame 100, cover 200, and actuator 300 are combined to form the knife 20, their interactions define three positions for the blade: a sheathed position, an exposed use position, and a travel position between the sheathed and use positions.

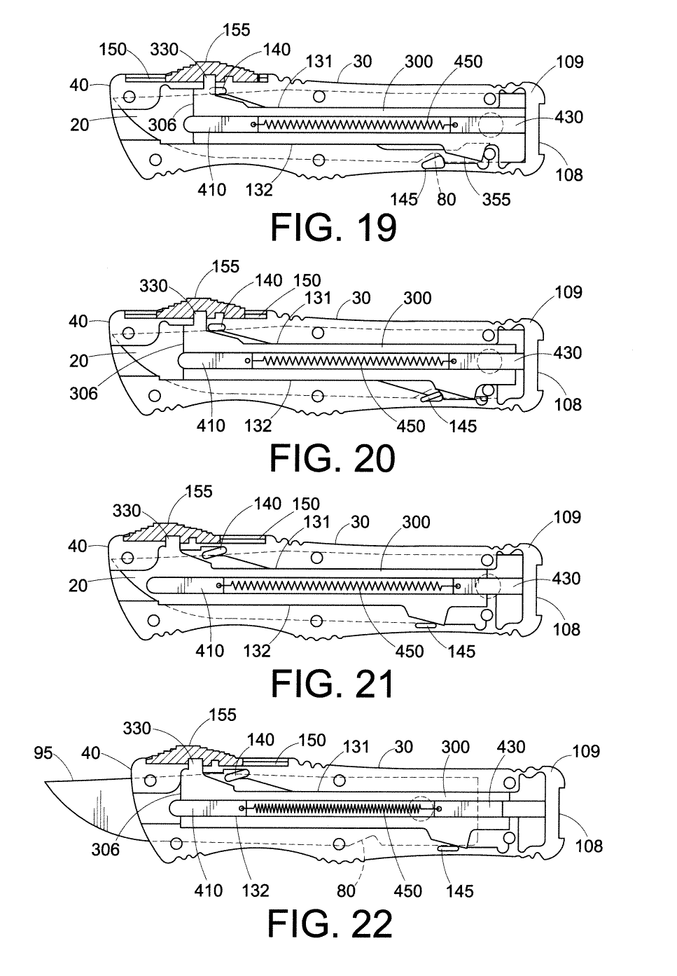

Referring to FIG. 19, the blade 20 is held within the handle 30 in the sheathed position by rear spring catch 145. The rear spring catch 145 is engaged and interfaces with blade catch 80, preventing the blade 20 from extending out the front end 40 of the knife. The tang length 55 is such that the rear wall 25 of the blade contacts the rear wall 109 of the frame. Because blade interface 435 fits into blade recess 70, rear catch 430 is pushed back to contact the rear wall 109. This causes front catch 410 to pull the actuator 300 backwards so that actuator rear end 308 contacts the rear wall 109 as well. However, note that energy is still stored in the spring 450 (because it is still stretched from its resting position; see FIG. 17). The trigger 155 is in its fully rearward position at the end of trigger channel 150 furthest from the front end 40.

In FIG. 20, the user has pushed the trigger 155 forward to about halfway along trigger channel 150 to begin releasing the blade 20. By pushing the trigger 155, the user overcomes the tension in the spring 450 which is holding the actuator 300 against the rear wall 109. Thus, the actuator 300 moves forward. The sloped ramp 340 no longer disengages the front spring catch 140 (i.e., the front spring catch 140 is now engaged. However, the rear spring catch 145 is still engaged and continues to hold the blade 20 in its sheathed position. The blade interface 435 is still held by blade recess 70 against the rear wall 109. This causes the spring 450 to extend more, storing more energy.

In FIG. 21, the trigger 155 has been pushed far enough forward that the angled face 355 of the rear spring catch interface 350 of the actuator 300 interfaces with and disengages the rear spring catch 145. Remember, the front and rear spring catches 140 and 145 intersect the blade channel 110 and the actuator channel 130. Now, the blade 20 is not prevented from moving forward and is in fact forced to do so by the energy which has been stored in spring 450. The blade interface 435 releases this energy into the blade 20, causing the blade 20 to move forward and extend out the front end 40 of the knife.

In FIG. 22, the blade 20 is in the travel position between the sheathed and use positions. In the travel position, neither the actuator 300, spring assembly 400, or either spring catch 140 or 145 are interacting with the blade 20. The rear catch 430 has returned to its resting position where it does not extend beyond the rear end 308 of the actuator. The shape of the actuator channel 130 prevents the actuator 300 from moving further forward. As the blade 20 travels out the front end 40 of the knife, the tapered blade, top 95 interfaces with the front spring catch 140, disengaging it to allow the blade to travel completely forward.

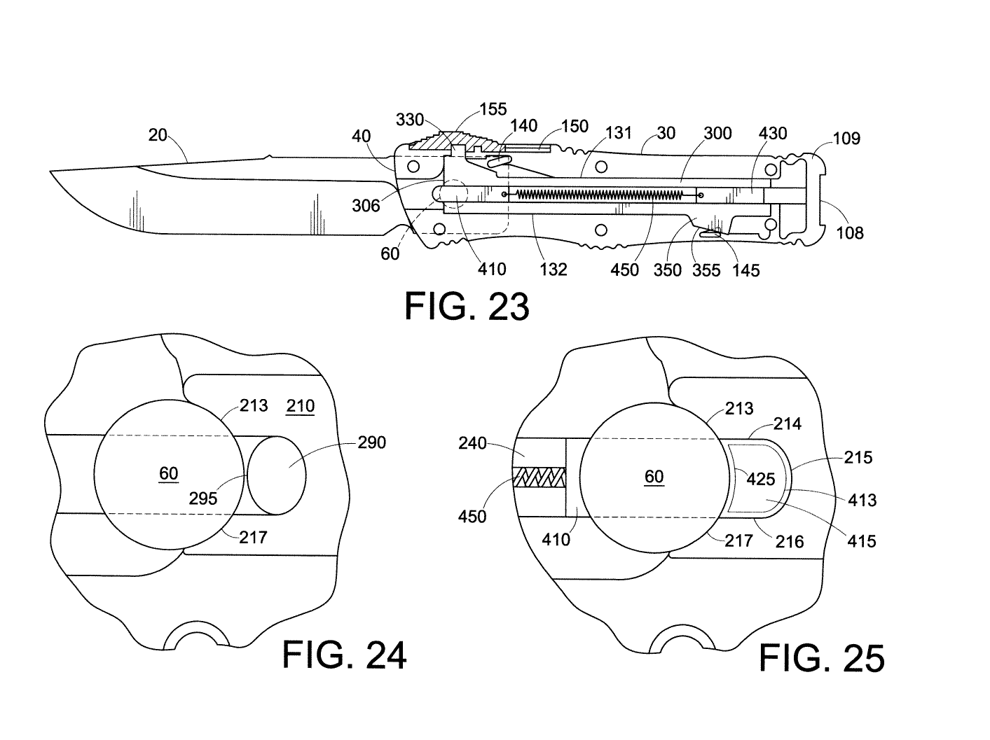

In FIG. 23, the blade 20 is in the extended use position. Now the blade 20 is held in position by the front spring catch 140 of the frame 100 and the extended stop 210 of the cover 200. The front spring catch 140, which is now engaged (since the blade top 95 has traveled past it) and contacts the rear end 25 of the blade, prevents the blade 20 from retracting into the handle 30. The blade 20 is prevented from moving further forward and exiting the handle 30 by the extended stop 210.

The extended stop 210, located on the cover 200, prevents the blade 20 from exiting the handle 30 by physically blocking the path of the blade pin 60. As previously discussed, continual striking of the blade pin 60 eventually distorts the aluminum frame of the knife. This striking results from the energy imparted to the blade 20 by the spring 450. In the knife of the present disclosure, the distortion is reduced or eliminated by the extended stop in at least two different embodiments.

The first embodiment is depicted in FIG. 24. The width 420 of the projection 415 of the front catch 410 of the spring assembly 400 does not engage the blade pin 65. Instead, the extended stop 210 contains a stop boss 290 which also has a width sufficient to engage the blade pin 60. The stop boss 290 is made of a material at least as hard as (or harder than) the material from which the blade pin 60 is made. In specific embodiments, the stop boss 290 is also made of steel. As the blade pin 60 travels forward with the blade 20, it contacts stop arcs 213 and 217. It also contacts the stop boss 290 at stop point 295, which absorbs most of the kinetic energy compared to stop arcs 213 and 217. However, because the stop boss 290 is made of a harder material than the extended stop 210, it can absorb the force without distortion.

The second embodiment is depicted in FIG. 25. The projection 415 of the front catch 410 of the spring assembly 400 has a width 420 sufficient to engage the blade pin 65. The actuator channel 130 is shaped so that the front catch 410, which extends beyond the front end 306 of the actuator 300, does not contact the interior surface 212 of the extended stop 210 when the spring assembly 400 is in its resting position. As the blade 20 travels towards its use position, the blade pin 60 eventually contacts the concave arc 425 of the projection 415. The concave arc 425 is shaped to accept the blade pin 60. The blade pin 60 pushes the projection 415 forward, thereby causing the spring 450 to absorb some of the kinetic energy of the blade 20. The projection 415 then travels in the catch channel 240 until the projection 415 and the blade pin 60 contact the interior surface 212 of the extended stop 210 (remember, the extended stop 210 is already wide enough to engage the blade pin 60 itself). The outer end 413 of the front catch 210, which is a convex semicircle, contacts the concave semicircle 215. The blade pin 60 contacts stop arcs 213 and 217. Any remaining energy is thus dissipated over a greater surface area to absorb the force without distortion. The extended stop 210 does not need to be made of material different from the rest of the frame 100 or cover 200. In this embodiment, the front catch 410 acts as the stop boss 290 of the embodiment depicted in FIG. 24.

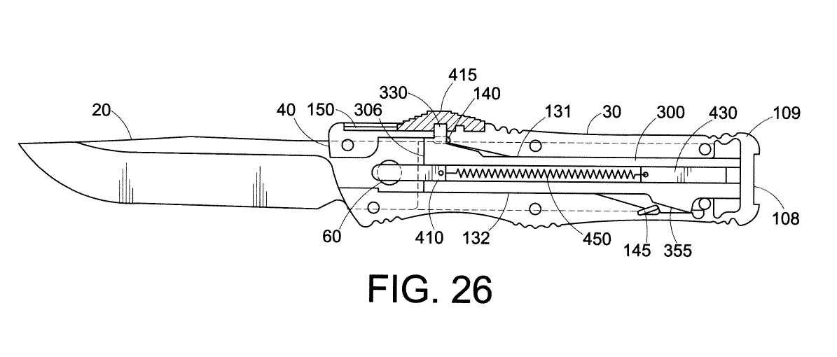

To move the blade 20 from the extended use position to its sheathed position, the front spring catch 140 must be disengaged. This is shown in FIG. 26. Disengagement occurs when the user moves the trigger 155 backwards in the trigger channel 150. This causes the sloped ramp 340 on the top of the actuator 300 to disengage the front spring catch 140. In the embodiment shown in FIG. 25, the blade pin 60 holds the front catch 410 in place as the actuator 300 moves backwards. This extends the spring 450, again storing energy. When the front spring catch 140 is disengaged, the energy is transferred back to the blade 20, causing the blade 20 to move back into the handle 30. As the blade 20 travels back into the handle 30, it will encounter rear spring catch 145 which is engaged. However, the rear end 25 of the blade will disengage the rear spring catch 145 so that the blade 20 can continue traveling until the blade catch 80 is encountered (see FIG. 22). This then engages the rear spring catch 145 to return to the sheathed position depicted in FIG. 19. In the embodiment shown in FIG. 24, the blade 20 must be pushed back into the handle 30 by the user.

The knife of the present disclosure has been described with reference to various exemplary embodiments. Obviously, modifications and alterations will occur to others upon reading and understanding the preceding detailed description. It is intended that the knife of the present disclosure be construed as including all such modifications and alterations insofar as they come within the scope of the appended claims or the equivalents thereof.

1. A knife, comprising:
a handle comprising a frame, a cover, and a handle front end;
a blade with a tang;
a blade pin having a blade pin hardness located on the tang facing the cover; and
a stop boss having a stop boss hardness at least as hard as the blade pin hardness;
the frame having a pin channel;
the cover comprising an extended stop which extends into the pin channel at the handle front end and is shaped to receive the stop boss; and
the stop boss being mounted in the extended stop.

2. The knife of claim 1, wherein the extended stop comprises an interior surface shaped to receive the blade pin.

3. The knife of claim 2, wherein the interior surface has an interior surface hardness that is less than the blade pin hardness.

4. The knife of claim 2, wherein the extended stop interior surface comprises two arcs, two line segments, and a semicircle.

5. The knife of claim 1, further comprising an actuator, a front spring catch, and a rear spring catch;
the frame having a frame top, a frame bottom, a frame front, and a frame rear;
the front spring catch being located near the frame top and the frame front;
the rear spring catch being located near the frame bottom and the frame rear; and
the actuator being shaped so as to engage each spring catch separately.

6. The knife of claim 5, wherein the handle further comprises a rear wall, the blade further comprises a blade catch and a rear end, the tang has a length defined by the distance between the blade catch and the blade rear end, and the rear spring catch is located so that the distance between the rear spring catch and the rear wall is substantially equal to or greater than the tang length.

7. The knife of claim 5, wherein the front spring catch and the extended stop are located so as to prevent the blade from moving substantially in a frontward or rearward direction when the blade is between the front spring catch and the extended stop.

8. The knife of claim 5, wherein the actuator further comprises a spring assembly, the spring assembly comprising a front catch, a rear catch, and a spring connecting the front catch and the rear catch.

9. The knife of claim 8, wherein the blade further comprises a blade recess located on a blade rear end; and
the rear catch comprises a blade interface that fits into the blade recess.

10. The knife of claim 8, wherein the actuator has a rear end, and the rear catch does not extend beyond the rear end when the spring assembly is in a resting position.

11. The knife of claim 1, further comprising a fastener system to attach the frame and cover together.

12. A knife, comprising:
a handle comprising a frame, a cover, and a handle front end;
a blade with a tang;
a blade pin having a blade pin hardness located on the tang facing the cover; and
an actuator comprising a spring assembly, the spring assembly comprising a stop boss;
the stop boss having a stop boss hardness at least as hard as the blade pin hardness, extending beyond a front end of the actuator, and having a width sufficient to engage the blade pin;
the frame having a pin channel;
the cover comprising an extended stop which extends into the pin channel at the handle front end and is shaped to receive the stop boss.

13. The knife of claim 12, wherein the stop boss has an outer end, the outer end having the shape of a convex arc; and
the extended stop comprises an interior surface, the interior surface comprising a concave arc shaped to receive the stop boss outer end.

14. The knife of claim 12, wherein the spring assembly further comprises a rear catch and a spring, the spring connecting the stop boss and the rear catch.

15. The knife of claim 14, wherein the blade further comprises a blade recess located on a blade rear end; and
the rear catch comprises a blade interface that fits into the blade recess.

16. The knife of claim 15, wherein the actuator has a rear end, and the rear catch does not extend beyond the rear end.

17. The knife of claim 12, further comprising a front spring catch and a rear spring catch;
the frame having a frame top, a frame bottom, a frame front, and a frame rear;
the front spring catch being located near the frame top and the frame front;
the rear spring catch being located near the frame bottom and the frame rear; and
the actuator being shaped so as to engage the front spring catch and rear spring catch separately.

18. The knife of claim 17, wherein the handle further comprises a rear wall, the blade further comprises a blade catch and a rear end, the tang has a length defined by the distance between the blade catch and the blade rear end, and the rear spring catch is located so that the distance between the rear spring catch and the rear wall is substantially equal to or greater than the tang length.

19. The knife of claim 17, wherein the front spring catch and the extended stop are located so as to prevent the blade from moving substantially in a frontward or rearward direction when the blade is between the front spring catch and the extended stop.

20. A knife, comprising:
a handle comprising a frame, a cover, and a handle front end;
a blade comprising a blade recess and a tang;
a blade pin having a blade pin hardness located on the tang facing the cover; and
an actuator comprising a spring assembly;
the spring assembly comprising a stop boss, a rear catch, and a spring connecting the stop boss and the rear catch;
the stop boss having a projection, the projection being shaped to engage the blade pin and having a width sufficient to extend into the pin channel;
the stop boss extending beyond a front end of the actuator;
the rear catch not extending beyond a rear end of the actuator and having a blade interface of a width sufficient to fit into the blade recess;
the frame having a pin channel, a frame top, a frame bottom, a frame front, and a frame rear;
the frame comprising a front spring catch located near the frame top and the frame front, and a rear spring catch located near the frame bottom and the frame rear;
the frame and cover together defining an actuator channel;
the actuator being shaped to engage the front spring catch and rear spring catch separately; and
the cover comprising an interior surface that extends into the pin channel at the handle front end and is shaped to receive the stop boss.
